(19) United States
(12) Patent Application Publication
(10) Pub. No.: US 2012/0215507 A1
(43) Pub. Date: Aug. 23, 2012

(54) SYSTEMS AND METHODS FOR AUTOMATED ASSESSMENT WITHIN A VIRTUAL ENVIRONMENT

(75) Inventor: Brett E. Shelton, Providence, UT (US)

(73) Assignee: UTAH STATE UNIVERSITY, North Logan, UT (US)

(21) Appl. No.: 13/402,801

(22) Filed: Feb. 22, 2012

Related U.S. Application Data
(60) Provisional application No. 61/445,417, filed on Feb. 22, 2011.

(51) Int. Cl. G06G 7/48

(52) U.S. Cl. 703/6

(57) ABSTRACT

The present disclosure relates to systems and methods for automated assessment within a virtual environment. Interactive simulation systems have a variety of applications for education and/or training applications, including education, military, and corporate contexts. Evidence-based assessment models may be embedded into interactive simulation systems and may further enhance the utility of such systems by automating the assessment of the performance of participants in a simulation. Evidence-based assessments may be established using a variety of criteria, including completeness, accuracy of performance, timeliness of the learning task, etc.

### RELATED APPLICATION

This U.S. patent application claims priority under 35 U.S.C. §119(e) to U.S. Provisional Patent Application No. 61/445,417, filed on Feb. 22, 2011. The disclosure of this prior application is considered part of the disclosure of this application and is hereby incorporated by reference in its entirety.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a conceptual representation of the results of three simulations utilizing a regeneration feature that may be utilized in connection with various systems and methods disclosed herein, according to one embodiment.

FIG. 2 illustrates a decision tree in open-ended complex virtual environment, according to one embodiment.

FIG. 3 illustrates a flow diagram of a method for automated assessment that may be utilized in connection with an educational and/or training program in a virtual environment, according to one embodiment.

FIG. 4 illustrates a flow diagram of a method for automated assessment of an accuracy component of an assessment-monitored event that occurs in a virtual environment, according to one embodiment.

FIG. 5 illustrates a flow diagram of a method for automated assessment of a completeness component of an assessment-monitored event that occurs in a virtual environment, according to one embodiment.

FIG. 6 illustrates a flow diagram of a method for automated assessment of a time-related component of an assessment-monitored event that occurs in a virtual environment, according to one embodiment.

FIG. 7 illustrates a flow diagram of a method for automated assessment of an assessment-monitored event that occurs in a virtual environment.

FIG. 8 illustrates a functional block diagram of a system for automated assessment of an assessment-monitored event within a virtual environment, according to one embodiment.

FIG. 9A illustrates a screen shot of one simulation that may be utilized for training a user to investigate and determine the cause of a fire, according to one embodiment.

FIG. 9B illustrates a screen shot of the simulation illustrated in FIG. 9A with an assessment log providing real-time feedback to the user.

FIG. 9C illustrates a screen shot of a portion of a log window that may be displayed to a user during the simulation illustrated in FIG. 9A and that shows feedback provided to a user using automated assessment.

### DETAILED DESCRIPTION

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail in order to avoid obscuring more important aspects of the disclosure.

Furthermore, the described features, operations, or characteristics may be combined in any suitable manner in one or more embodiments. It will also be readily understood that the order of the steps or actions of the methods described in connection with the embodiments disclosed herein may be changed as would be apparent to those skilled in the art. Thus, any order in the drawings or detailed description is for illustrative purposes only and is not meant to imply a required order, unless an order is specifically stated.

Embodiments may include various steps, which may be embodied in machine-executable instructions executed by a general-purpose or special-purpose computer or other electronic device. Alternatively, the steps may be performed by hardware components that include specific logic for performing the steps, or by a combination of hardware, software, and/or firmware.

Embodiments may also be provided as a computer program product including a computer-readable medium having stored thereon instructions that may be used to program a computer or other electronic device to perform the processes described herein. The computer-readable medium may include, but is not limited to: hard drives, floppy diskettes, optical disks, CD ROMs, DVD ROMs, ROMs, RAMs, EPROMs, EEPROMs, magnetic or optical cards, solid-state memory devices, or other types of media/computer-readable medium suitable for storing electronic instructions.

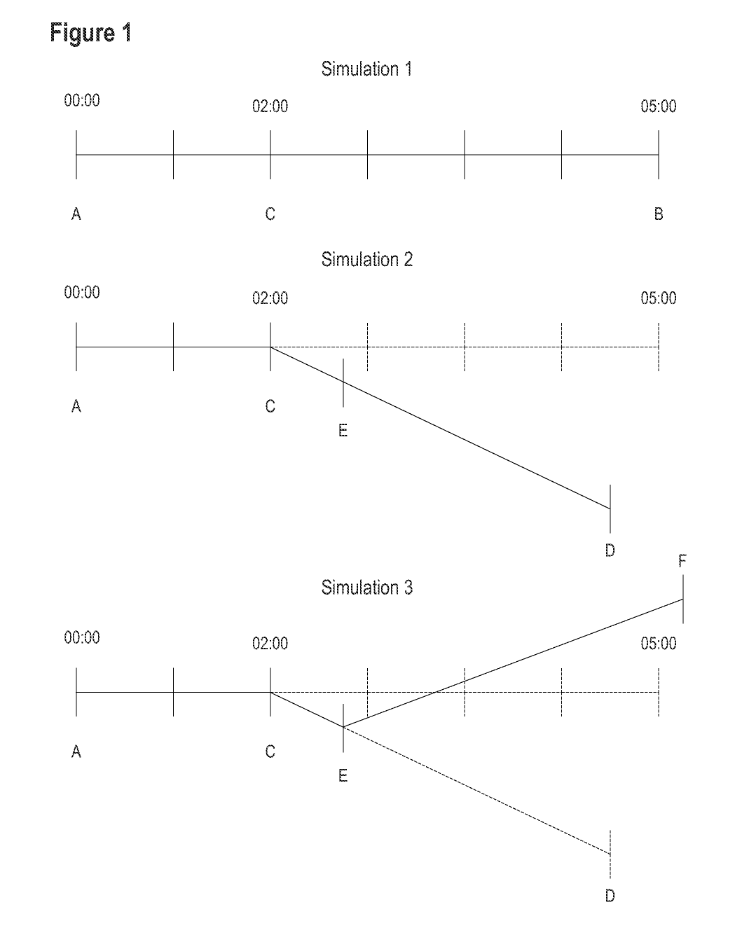

FIG. 1 illustrates a conceptual representation of the results of three simulations created using a regeneration feature, which may be utilized in connection with an automated assessment system. In one embodiment, a designer of a simulation may create a configuration file incorporating various features for a variety of instructional purposes. For example, one feature consists of saving, replaying, and regenerating the simulation. That is, each simulation can be saved and played back for review during an after-action-review (“AAR”) session to aid in learning. The data that is saved for play back may be kept separate from the simulation engine, and thus may be transferred and viewed by different users. The transfer and distributions of the same pre-built or saved simulations may be viewed and experienced by a potentially unlimited number of users in order to replicate a specific educational or training situation. Distributing simulations may standardize the assessment of a plurality of users. The use of standardized assessments allows users who may be distributed across time and distance to operate within the same simulation, and further allows each user to proceed through the simulation based on the user's knowledge and skill. Comparison of the performance of users in response to a standardized simulation may allow instructors to assess each user's performance relative to other users in an open-ended simulation environment.

A saved simulation may be regenerated at any point along a saved timeline. The regeneration feature may be used to create multiple outcomes based on a single simulation. FIG. 1 illustrates a timeline, in which a key decision was made during the simulation at 2 minutes. The key decision is represented at point “C”. At point “C” a new simulation may be created, and a different decision may be made at point “C,” thus leading to a new outcome. Simulation 2 contains the same actions as simulation 1 from time 00:00 to 2:00. During play back of Simulation 2, another key decision may be made at point E. A new regeneration from point E could result in yet another new simulation, which is designated as Simulation 3. The saved behaviors and actions may be identical from points A-C-E within simulations 2 and 3. Further, all three simulations include the same content between points A-C, yet all three simulations have different outcomes. Points, B, D, and F are the arbitrary “end” points in the simulation, dictated by completion of the activities. The use of a regeneration feature in a simulation system may provide advantages, including: (1) allowing learners the opportunity to immediately learn from their mistakes without having to repeat already correctly performed actions, and (2) allowing review and replay to assist in identifying alternatives during critical points of a simulation.

In one embodiment, the regeneration of a potentially infinite number of simulations based on a single saved simulation is possible by storing state information relating to the simulation in a file and regenerating the simulation using the stored state information. The data for each component of the simulation may be fed into the game engine. This data may be multi-faceted and may comprise data for each component of the model (e.g., the position of the component, the state of key variables within the simulation, audio associated with the simulation, etc.). Each piece of data may be coordinated to the timing of the simulation. The way the data is coordinated may allow for regeneration of a simulation from any time (t), while retaining all previous data before time (t), and initiating a new simulation beyond time (t).

The regeneration feature allows for the creation of a saved simulation that could be distributed to a plurality of users in a geographically diverse, asynchronous manner. Each user may experience playback of the saved simulation up to a specified time (t), at which point the user may create a new simulation. The new simulation may then be compared to the performances of other users, thus offering a standardized assessment of an open-ended, 3D simulation across a plurality of participants. According to some embodiments, a comparison may be made on a novice-to-expert scaling. In other words, rather than providing feedback as being “correct” or “incorrect”, open ended environments allow for different decision making at different times. Improvement, or learning, by a user may be assessed by comparing the user's actions to that of an expert in the field. The closer the match to what the expert did, the more the user is judged as being expert-like, along a novice-to-expert spectrum of possible results.

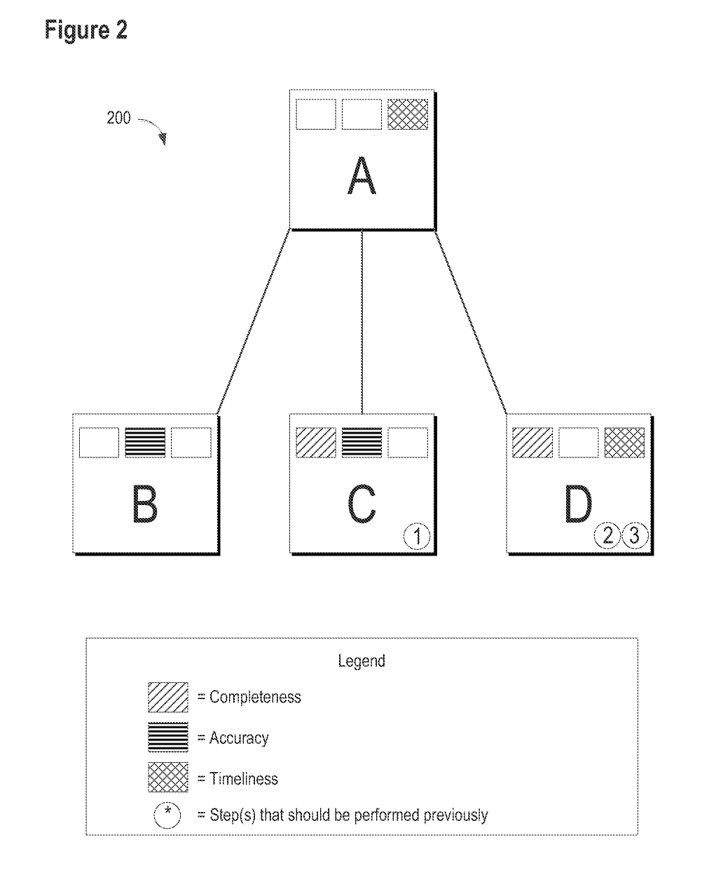

FIG. 2 illustrates a simplified decision tree 200 that may be utilized in connection with one embodiment of an open-ended virtual environment. Decision tree 200 may track complex decision-making by a user, and may facilitate automated assessment and generation of user feedback. According to one embodiment, when the user focuses on a particular node within decision tree 200 (i.e., node “A”) within a simulation, the user is presented with different choices or decisions (i.e., progressing to nodes B, C, or D). Each choice or decision made by the user may be noted within the simulation.

The automated assessment feature may identify dependent/independent relationships, store information about the simulation activity, and may provide an evidence-based assessment of a number of variables relating to the simulation. According to one embodiment, assessment variables include: (1) completeness (e.g., a determination of whether all activities in a task are performed); (2) accuracy (e.g., a determination of the accuracy of the decisions); and (3) timeliness (e.g., a determination of the actual time spent on a task in comparison to time parameters assigned to the task and/or the amount of time between tasks). For example, a dependent relationship may imply that a user must perform one task before another task (e.g., task 1 must be completed before task 2). In another example, an independent relationship may exist between two tasks, and thus, a user may perform the tasks at any time, without regard to the sequence in which the tasks are performed. A system for automated assessment may be programmed to determine appropriate relationships between various dependent and independent tasks and may increment or decrement a user's assessment based on whether the user correctly manages tasks with dependent and independent relationships. According to various embodiments, the automated assessment feature may be based on an exemplary simulation, and the assessment may identify divergences between the exemplary simulation and the user's performance.

Each node of decision tree 200 may include information about criteria to be evaluated in conjunction with the node. For example, according to the illustrated embodiment, node A is to be evaluated for timeliness, node B is to be evaluated for accuracy, node C is to be evaluated for completeness and accuracy, and node D is to be evaluated for completeness and timeliness. Further, decision tree 200 may also specify one or more steps that should have been performed previously. For example, in the illustrated embodiment, node C indicates that step 1 should have already been performed, and node D indicates that steps 2 and 3 should have already been performed. If a user fails to perform the tasks in the order required, the user's assessment may be decremented.

Certain embodiments may allow for modification of a portion of a decision tree without recreating the entire decision tree. For example, certain embodiments may allow a designer to directly alter the way an existing assessment event is handled without recreating the entire design of the assessment, or the simulation. Having the ability to easily modify the way complex decision trees are implemented within a simulation offers instructional flexibility for multiple simulations, changes the way decisions are presented or manifested, and allows for modification along the spectrum for novice-to-expert education. According to one embodiment, the stored decisions are exported to a log file that can be assessed by an instructor. The ability to export the stored decisions to a log file may facilitate the transmission of the log file to a remotely located instructor.

In conjunction with a decision tree, such as decision tree 200, an automated assessment function may assess the actions and decisions made by the user during the simulation. The automated assessment function may also generate data that can be exported to a log file for review by an instructor. Annotations may, according to various embodiments, also be included in the log file. The automated assessment function may collect data in real-time and during an AAR session relating to the simulation. Review of the automated assessment data may enable the analysis and distribution of understandable and customized feedback to both the instructor and the learner for both synchronous and asynchronous assessment.

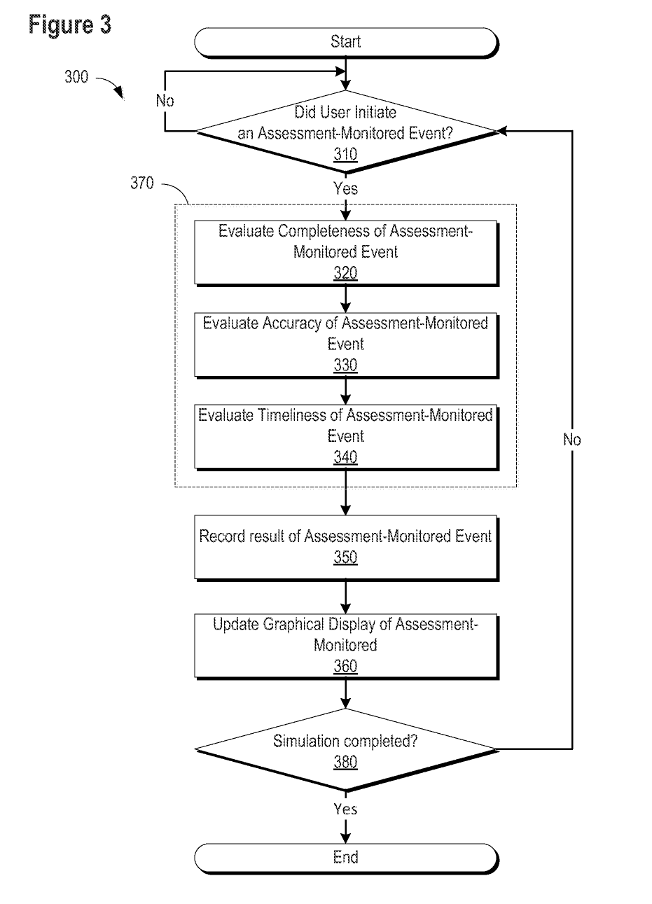

FIG. 3 illustrates a flow diagram of a method 300 for automated assessment that may be utilized in connection with an educational and/or training program in a virtual environment, according to one embodiment. At 310, it may be determined whether a user initiated an assessment-monitored event. When a user initiates an assessment-monitored event, an automated assessment process 370 may begin. According to the illustrated embodiment, automated assessment process 370 comprises an evaluation of the completeness of the assessment-monitored event 320, an evaluation of the accuracy of the assessment-monitored event 330, and an evaluation of the timeliness of the assessment-monitored event 340. More or fewer assessments may be included within automated assessment process 370, according to various embodiments. Further, as illustrated in connection with FIG. 2, certain assessment-monitoring events may only be evaluated for one or more criteria (e.g., completeness, accuracy, or timeliness). At 350, the results of the assessment-monitored event may be recorded.

Various embodiments may include a graphical display for providing immediate feedback to the user based upon the results of the automated assessment process 370. According to such embodiments, at 360 a graphical display of the assessment may be updated. The use of a graphical display of the assessment may train users by providing immediate feedback and allowing users to appropriately adjust their conduct. According to other embodiments, the feedback can be hidden, in order to allow the user participation without receiving immediate feedback from the automated assessment process 370. Hiding the assessment may allow an instructor additional options for testing users, especially when combined with the standardized simulations that have been previously described. At 380, method 300 may determine whether the simulation is complete. If so, method 300 may terminate. If the simulation is not completed, method 300 may return to 310 and proceed as described above.

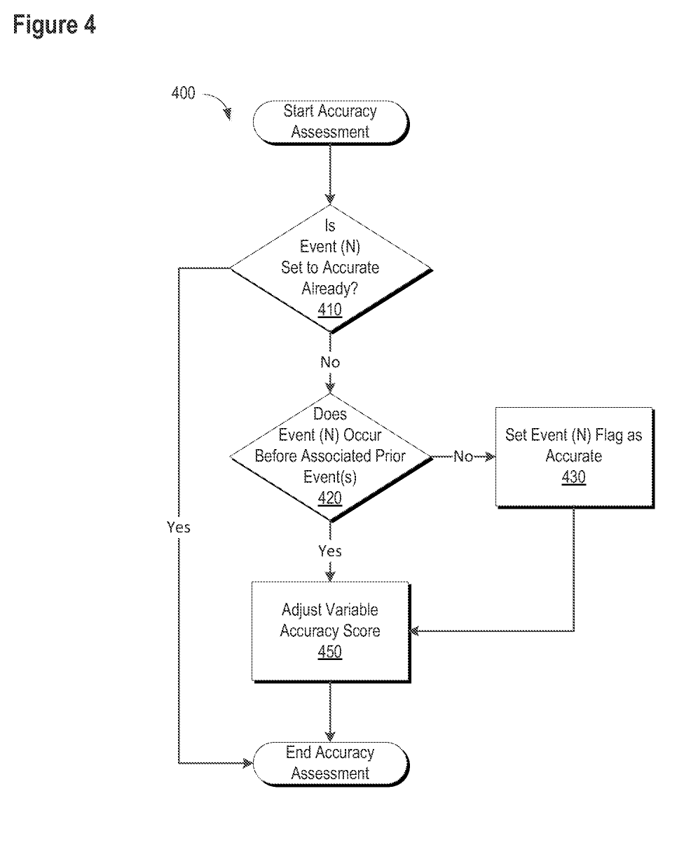

FIG. 4 illustrates a flow diagram of a method 400 for automated assessment of an accuracy component of an event that occurs in a virtual environment. At 410, method 400 determines whether an indicator associated with an event (N) is already set to reflect that event (N) has been accurately performed. If the event has already been accurately performed, the accuracy assessment may end. If not, at 420, method 400 may determine whether event (N) occurs before associated prior events. If so, the user has failed to execute event (N) in the appropriate sequence, and accordingly, a variable accuracy score may be decremented at 450. If the event (N) does not occur before associated prior event(s), a flag for event (N) may be set as accurate, at 430. Further, the variable accuracy score may be incremented at 450 based upon the accurate completion of Event (N). The amount of increment or decrement the variable accuracy score may be designated in the design of the simulation.

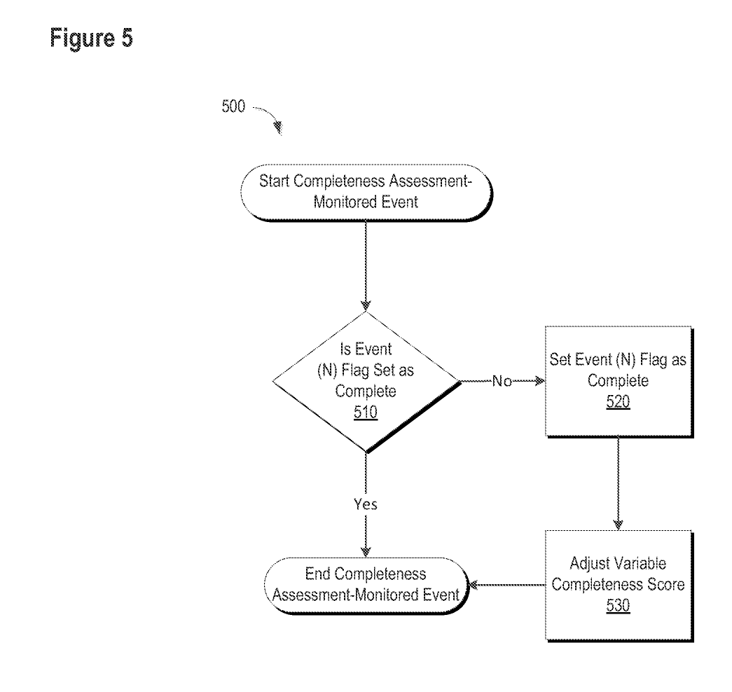

FIG. 5 illustrates a flow diagram of one embodiment of a method 500 for automated assessment of a completeness component of an event (N) that occurs in a virtual environment. At 510, it may be determined whether a flag associated with the assessment-monitored event (N) has been completed. If the flag associated with the event (N) is already set as complete, method 500 may terminate. If not, at 520, the flag associated with assessment-monitored event (N) may be set as complete. At 530, a variable completeness score may be adjusted, and method 500 may terminate.

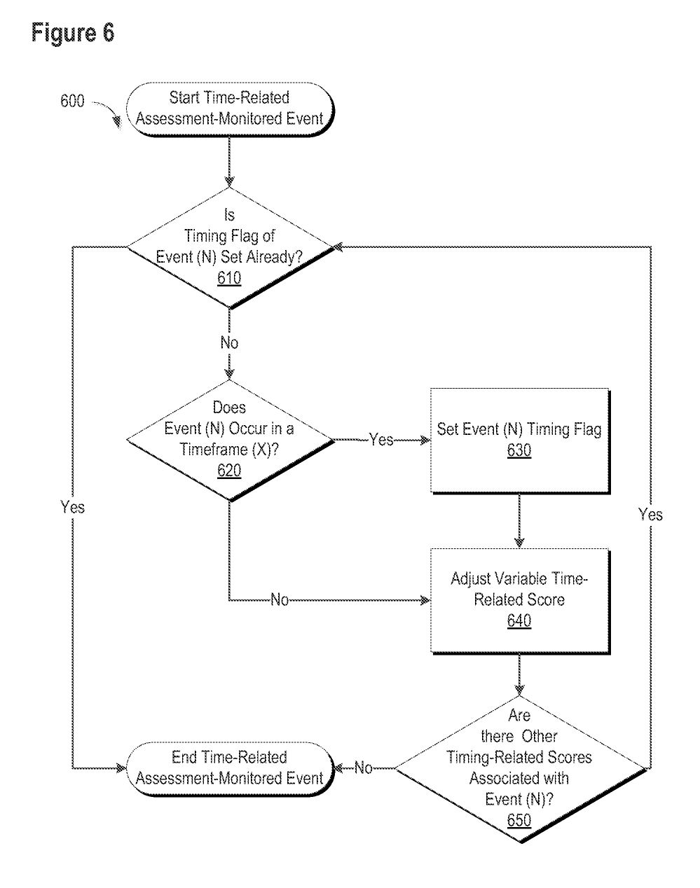

FIG. 6 illustrates a flow diagram of a method 600 for automated assessment of a time-related component of an event that occurs in a virtual environment, according to one embodiment. At 610, method 600 may determine whether a timing flag associated with an event (N) is already set. The flag associated with the event (N) may indicate that the event (N) has already been completed within a specified time frame. Accordingly, if the timing flag has already been set, method 600 may terminate. If the timing flag has not been set, it may be determined at 620 whether the event (N) occurs within a specific timeframe (X). The timeframe may be established by the requirements of a particular simulation. If event (N) occurs during timeframe (X), the timing flag associated with event (N) may be set. From 620 or 630, an adjustment may be made to a variable time-related score at 640. If event (N) occurs outside of timeframe (X), the variable time-related score may be decremented. If event (N) occurs within timeframe (X), the variable time-related score may be incremented. At 650 it may be determined whether other timing-related scores are associated with event (N). If not, method 600 may terminate. If additional timing-related events are associated with event (N), method 600 may return to 610 and proceed as described above.

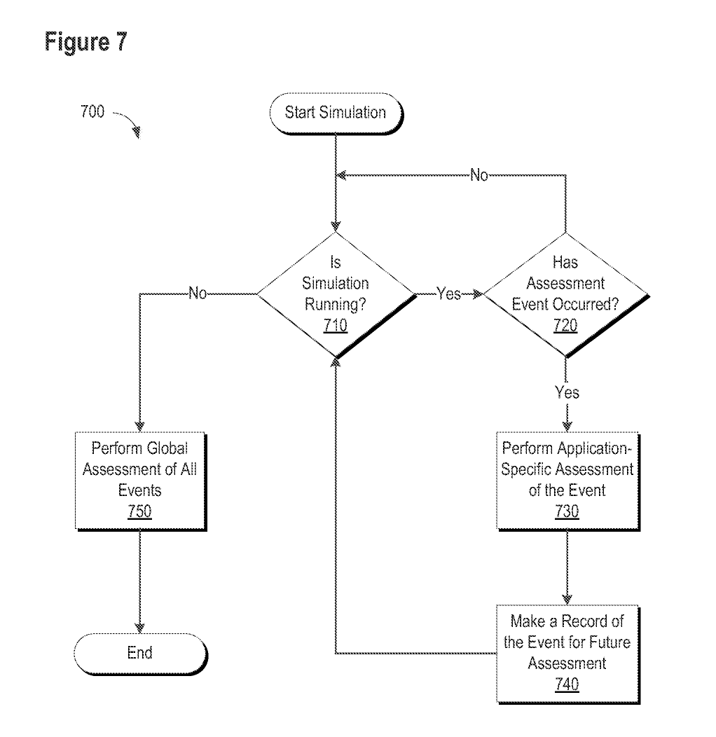

FIG. 7 illustrates a flow diagram of a method 700 for automated assessment of an event in connection with a simulation system. At 710, it may be determined whether a simulation is running. If so, method 700 may determine whether an assessment-monitored event has occurred at 720. Upon the occurrence of an assessment-monitored event, application-specific assessment of the events may occur at 730. Assessment of the event may include evaluation of one or more characteristics of the event (e.g., accuracy, timeliness, completeness, etc.). At 740 a record of the event may be made for future assessment. If it is determined at 710 that a simulation is not running, a global assessment of all events may be performed at 750. In other words, all events awaiting assessment may be processed at 750 and a complete record of all assessments may be generated.

As previously described, various embodiments may allow for the selective regeneration of a simulation from an arbitrary point within the simulation. Regeneration of the simulation may leverage asynchronous assessment by allowing any number of users to experience a saved simulation from a first-person perspective. The simulation files may be electronically transmitted by an instructor to one or more users. After completion of the simulation, users may transmit to the instructor the results of an automated assessment of the user's performance. Accordingly, the users may perform the simulation at any time or place, and the instructor may review the results of the simulation at any time or place. Further, the simulations can be practiced, recorded, and re-recorded as many times as the user wishes, then sent to the instructor, and graded. Further, the learning process may continue if the instructor sends an annotated log back to the user with instructions for regenerating the simulation and correcting certain conduct.

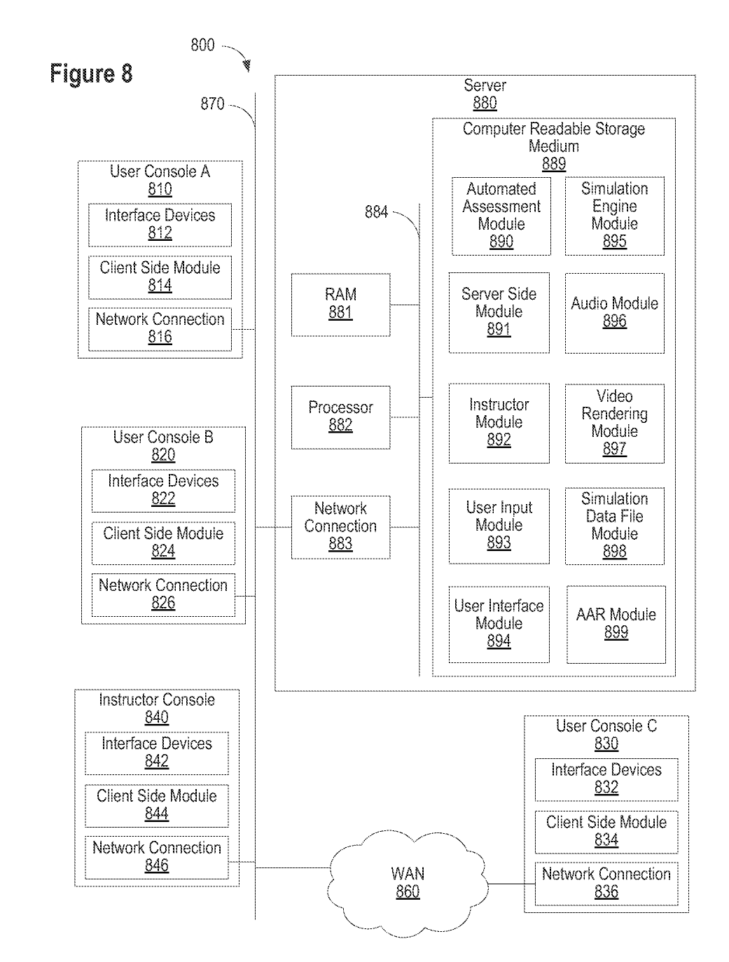

FIG. 8 illustrates a functional block diagram of one embodiment of a system 800 for automated assessment within a virtual environment. A plurality of user consoles 810, 820, 830 and an instructor console 840 are connected by a network 870 to a server 880. As illustrated, user console A 810 and user console B 820 may be connected by a local area network (LAN), while user console C 830 may be connected by a wide area network (WAN) 860. The network 870 may carry data traffic between the user consoles 810, 820, 830, the instructor console 840, and the server 880. According to various embodiments, the connectivity of each console may be varied, but any console may be connected by way of WAN 860 or network 870. Further, any of consoles 810, 820, 830, or 840 may be connected to server 880 at the same time or at different times.

The user consoles 810, 820, 830, and the instructor console 840 may be implemented in a variety of ways, such as computers, workstations, terminals, virtual machines, and the like. The plurality of user consoles 810, 820, and 830, may each respectively include user interface devices 812, 822, 832, a client side module 814, 824, 834, and a network connection 816, 826, 836. The user interface devices 812, 822, 832 may allow a user to interact with a simulation via the respective user console. Such interaction may include providing input to the simulation system and receiving input from the simulation system. The client side module 814, 824, 834, may interact with a server side module 891 resident on the server 880. FIG. 8 illustrates a system with three user consoles 810, 820, 830 and a single instructor console 840; however, it is contemplated that the system 800 may comprise any number of client and instructor consoles. One of skill in the art will recognize that the present disclosure may be adapted to include more or fewer client and instructor consoles than are illustrated in FIG. 8.

The server 880 may include RAM 881, a processor 882, a network connection 883, and a computer-readable storage medium 889. The processor 882 may be embodied as a general purpose processor, an application specific processor, a microcontroller, a digital signal processor, or other device known in the art. The processor 882 performs logical and arithmetic operations based on program code stored within the computer-readable storage medium 889. The computer-readable storage medium 889 may comprise various modules for simulating and regenerating a virtual environment and conducting an automated assessment of a user's performance. Such modules may include an automated assessment module 890, a server side module 891, an instructor module 892, a user input module 893, a user interface module 894, a simulation engine module 895, an audio module 896, a video rendering module 897, a simulation data file module 898, an AAR module 899, and an automated assessment module 890. Each module may perform a particular task associated with the simulation and regeneration of the virtual environment and/or the automated assessment of a user's performance within the virtual environment. One of skill in the art will recognize that certain embodiments may utilize more or fewer modules than are shown in FIG. 8. In certain embodiments, for example, additional modules may include texture modules, simulation specific modules, graphic modules, modules for interacting with specific user interface devices, and the like.

The automated assessment module 890 may be configured to identify assessment-monitored events and to generate an evidence-based assessment based on one or more evaluated criteria (e.g., accuracy of a task, completeness of a task, timeliness of a task, etc.). Various methods for assessing these criteria are discussed above in connection with FIGS. 4, 5, and 6. Further, the automated assessment module 890 may be configured to implement a decision tree that includes a plurality of nodes. The plurality of nodes may correspond to a variety of assessment-monitored events. The nodes may include data about which of a variety of criteria are to be evaluated in connection with the node, and which tasks are dependent on other tasks and the relative order in which dependent tasks are to be performed.

The server side module 891 may interface with the client side modules 814, 824, 834. The server side module 891 may handle communication with the client side modules 814, 824, 834. The server side module 891 may allow clients to join or exit the simulation. The server side module 891 may interpret or translate input received from the various consoles.

The user input module 893 may process input from interface devices 812, 822, 832, 842. Interface devices 812, 822, 832, 842 may include a keyboard, a mouse, a joystick, a microphone, a motion sensing component, and the like. The input received from interface devices 812, 822, 832, 842, may be communicated to the simulation engine module 895, or other modules as appropriate.

The user interface module 894 may be responsible for generating the user interface displayed to each client, while the simulation engine module 895 is responsible for the rules of a simulation and for the interaction between the simulation and the users. For example, the simulation engine module may govern the physics of the virtual environment, may animate characters, may enforce certain rules, and the like. In a simulation for training firefighters, for example, the simulation engine module 895, may govern how a fire spreads through a structure. Further, the actions of the users may govern how the simulation evolves. The simulation engine module 895 may generate an open ended simulation, such that an infinite number of possible alternatives may occur based on the rules of the simulation and the actions of the users. In an open ended simulation, there is no fixed outcome and no series of predetermined branches that force a particular outcome in a simulation. Accordingly, any one user's actions can drastically alter the outcome of the simulation.

In some embodiments, the simulation engine module 895 may generate a three-dimensional simulation environment. For example, in one simulation for training firefighters, the environment may be a home, where in another simulation, the environment may be an airplane. Accordingly, the firefighters may train for a variety of situations utilizing the same simulation system 800.

The user interface module 894 may also be responsible for providing feedback to a user based upon assessment-monitored events. For example, the user interface module 894 may display feedback to a user, including a log window that displays information related to the user's actions within the simulation. Further, the user interface module 894 may also display a visual indication to the user related to the user's performance with respect to completeness, accuracy, and timeliness of tasks to be completed in the simulation.

The simulation engine module 895 may coordinate the functions of various other modules and may receive input from the users and the instructor in order to allow the users and the instructors to interact with the simulation. For example, the simulation engine module 895 may pass updates to the audio module 896, the video rendering module 897, the user interface module 894, and the automated assessment module 890.

The audio module 896 may be responsible for allowing the users to communicate with each other and for generating audio signals related to the simulation. The audio module 896 may allow users to practice using communications protocols that are based on the real-world environment being simulated. The audio module 896 may generate appropriate audio signals related to the simulation. For example, the noises of a fire may be generated in an appropriate simulation.

The video rendering module 897 may be responsible for generating data necessary to visually present the virtual environment to the users. The data regarding the state of the virtual environment may be received from the simulation engine module 895. The video rendering module 897 may send data to each console 810, 820, 830, and 840, each of which may generate a unique visual representation of the virtual environment. The simulation engine module 895 may update the simulation at a particular rate (e.g., 60 times per second); however, in certain applications a higher refresh rate may be used to ensure that objects appear to move smoothly. Each console 810, 820, 830, and 840 may interpolate between the last rendering and the current state of the virtual environment so as to make objects appear to move smoothly.

The simulation data file module 898 may be responsible for compiling all data necessary for regenerating a simulation and storing automated assessment information from a simulation. In one embodiment, the simulation data file module 898 receives input from the automated assessment module 890, the user input module 893, the simulation engine module 895, and the audio module 896. All of the information is stored in a simulation data file, which may be saved and used to review and regenerate the simulation. Further, the automated assessment information may be extracted from the simulation data file by an instructor following a simulation.

The simulation data file module 898 may generate a simulation data file in any format that accommodates the types of data to be recorded. Recording user inputs to the simulation may reduce the size of a simulation data file when compared to storing a video representation of the simulation. Further, by storing the user inputs and states of the simulation, the simulation may be reviewed from different viewing angles and analyzed in other ways. For example, the entire simulation may be executed from a first person view, but reviewed from a top down view to illustrate how the users interacted with each other during the course of the simulation.

The AAR module 899 may be responsible for controlling the review of a simulation in an AAR mode. The AAR module 899 may provide functionality for accessing data in a stored simulation data file and providing the data to the simulation engine module 895 in such a way that the stored simulation can be reviewed by the users. The AAR module 899 may allow the review of a simulation to be controlled using controls such as skip to the beginning or end of a simulation, fast forward, rewind, pause, stop, or a scrubber bar. The AAR module 899 may allow certain events to be flagged for review. The AAR module 899 may cause a stored simulation data file to be fed into the simulation engine module 895, as if the simulation were occurring in real-time.

In alternative embodiments, a peer-to-peer system may be employed instead of the server-client system shown in FIG. 8. In such embodiments, the various modules illustrated in connection with the server 880 may be executed on one or more peer computers. Alternatively, various modules that are illustrated as being associated with the server 880 may be associated with the consoles 810, 820, 830, or 840. Further, users may interact directly with server 880, rather using consoles 810, 820, 830, or 840.

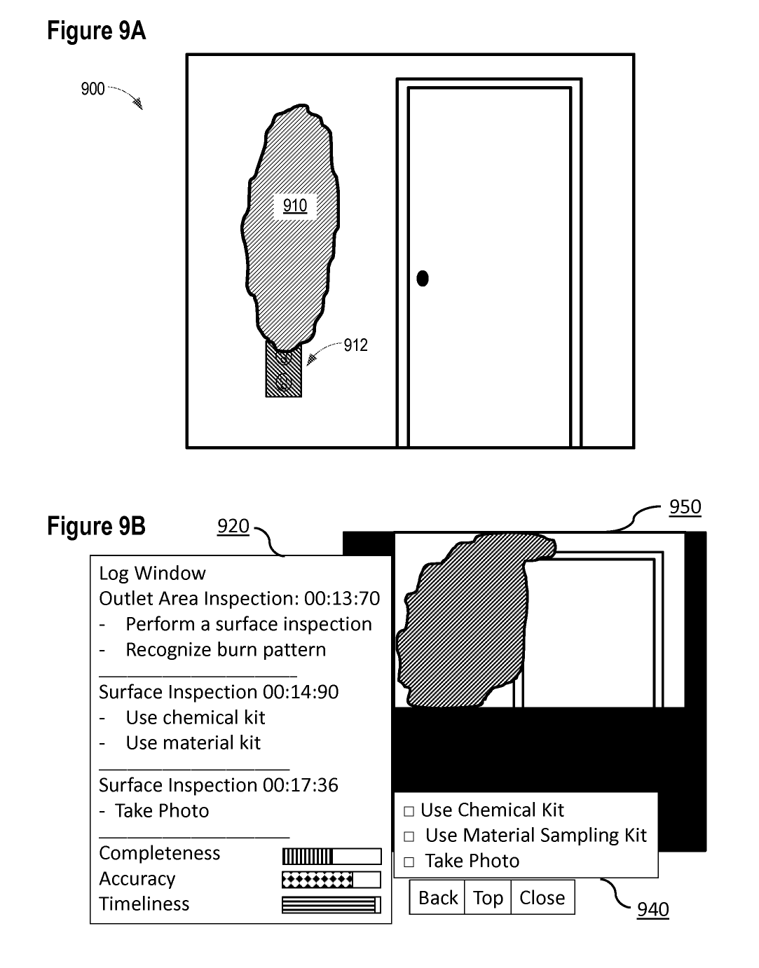

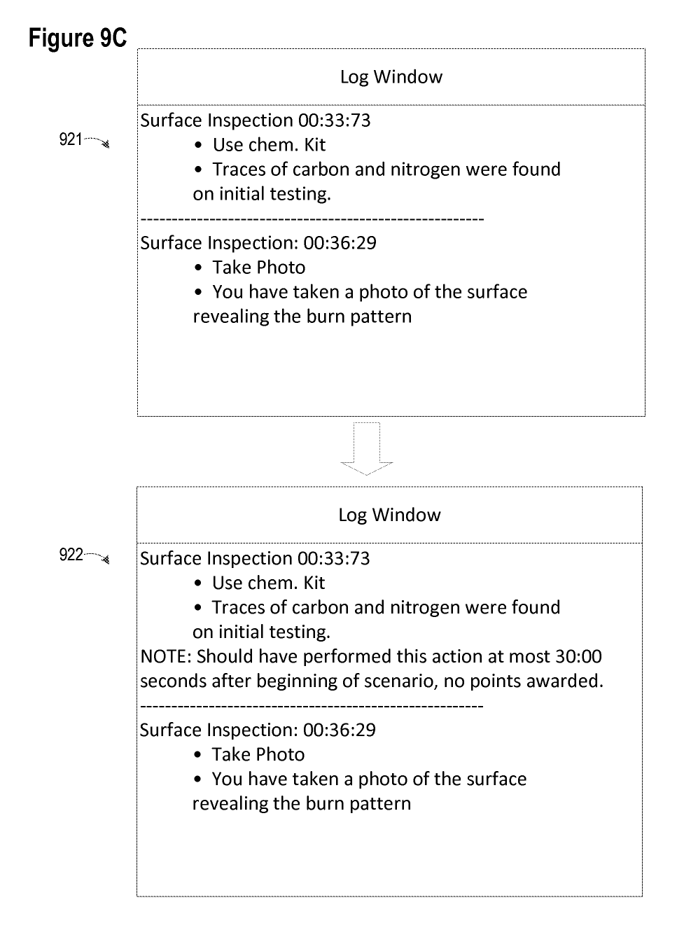

FIG. 9A illustrates a screen capture 900 from one embodiment of a system for automated assessment within a virtual environment that may be used for training firefighters. In the illustrated simulation, a burn mark 910 extends from an electrical outlet 912. The burn mark 910 should prompt the user to investigate and determine the source of the fire. When the user initiates an assessment-monitored event (e.g., an investigation of the wall) an image of the affected area 950 is shown in FIG. 9B, and a series of options 940 to investigate the burn incident are presented.

FIG. 9B illustrates a log window 920 that contains information related to the user's actions within the simulation. For example, information may be shown to a user in the log window 920, such as: the order of decisions, the amount of time to make those decisions, and completion of tasks scored on completeness, accuracy, and timeliness.

FIG. 9B also illustrates a progress indicator 930 that provides a visual indication to the user of the user's performance with respect to completeness, accuracy, and timeliness of tasks to be completed in the simulation. The progress indicator may be presented in a variety of formats according to various embodiments. For example, the progress bar may move to the right as the user progresses. Certain embodiments may provide immediately updated feedback associated with every action. Other embodiments may provide feedback only after the user completes the full set of actions within the task.

FIG. 9C illustrates one way in which varying levels of information may be presented to a user. Specifically, FIG. 9C illustrates a view of a first log window 921 in which an additional feedback feature is deactivated, and a view of a second log window 922 in which the additional feedback feature is activated. As indicated by comparing the first log window 921 to the second log window 922, a note is shown in the second log window 922 that states: “NOTE: Should have performed this action at most 30.00 seconds after beginning of simulation, no points awarded.” Varying amounts of information may be displayed during a simulation depending upon the instructional goals, the progress of the user, the type of practice imposed by the instructor, and whether or not the activity was part of practice or an exam. As illustrated in FIG. 9C, the additional information selectively displayed to the user may relate a deficiency in the user's performance of an assessment-monitored event.

It will be understood by those having skill in the art that many changes may be made to the details of the above-described embodiments without departing from the underlying principles of the invention. The scope of the present invention should, therefore, be determined only by the following claims.

I claim:

1. A simulation system, comprising:
a processor;
a user console configured to allow a player to provide input to a simulation system and further configured to display a user interface comprising a simulation environment;
a computer-readable storage medium in communication with the processor and the user console, the computer-readable storage medium comprising:
a simulation engine module executable on the processor, the simulation engine module operable to receive input from the user console and to generate the simulation environment;
a user interface module executable on the processor, the user interface module operable to generate the user interface comprising the simulation environment;
an automated assessment module executable on the processor, the automated assessment module operable to identify a plurality of assessment-monitored events and to generate an evidence-based assessment associated with the plurality of assessment-monitored events based on one or more evaluated criteria; and
a simulation data file module executable on the processor, the simulation data file module operable to generate an automated assessment output file containing the evidence-based assessment.

2. The simulation system of claim 1, wherein the automated assessment module further comprises a decision tree including a plurality of nodes, the plurality of nodes corresponding to the plurality of assessment-monitored events.

3. The simulation system of claim 2, wherein at least one of the plurality of nodes comprises an indication of an evaluated criteria associated with the corresponding assessment-monitored event.

4. The simulation system of claim 2, wherein at least one of the plurality of nodes comprises an indication that the corresponding assessment-monitored event includes a dependent task to be performed in a specified sequence relative to the corresponding assessment-monitored event.

5. The simulation system of claim 1, wherein the evaluated criteria comprises accuracy of the user's response to the assessment-monitored event, completeness of the user's response to the assessment-monitored event, and timeliness of the user's response to the assessment-monitored event.

6. The simulation system of claim 1, wherein the user interface module is further operable to display a log window comprising information related to the user's actions within the simulation.

7. The simulation system of claim 6, wherein the user interface module is further operable to selectively display feedback to the user in the log window identifying a deficiency in the user's performance of an assessment-monitored event.

8. The simulation system of claim 1, wherein the user interface module is further operable to display a visual indication to the user related to the user's performance with respect to the plurality of assessment-monitored events.

9. The simulation system of claim 1, wherein the simulation engine module generates a three-dimensional and open-ended simulation environment.

10. The simulation system of claim 1, wherein the automated assessment output file is transferable to a second simulation system.

11. The simulation system of claim 1, wherein the computer-readable storage medium further comprises a regeneration module operable to regenerate a plurality of simulations at a plurality of regeneration points.

12. A method of assessing a user's performance during a computer generated simulation, the method comprising:
generating a simulation environment responsive to input received from a user;
displaying the simulation environment to the user;
determining that a user has initiated an assessment-monitored event;
generating an evidence-based assessment associated with the assessment-monitored event; and
storing the result of the assessment-monitored event.

13. The method of claim 12, further comprising identifying a node in a decision tree associated with the initiated assessment-monitored event.

14. The method of claim 13, further comprising identifying an evaluated criteria in the node associated with the corresponding assessment-monitored event.

15. The method of claim 13, further comprising identifying a dependent task to be performed in a specified sequence relative to the corresponding assessment-monitored event.

16. The method of claim 12, wherein generating the evidence-based assessment associated with the assessment-monitored event comprises one of assessing the accuracy of the user's response to the assessment-monitored event; assessing the completeness of the user's response to the assessment-monitored event; and assessing the timeliness of the user's response to the assessment-monitored event.

17. The method of claim 12, further comprising:
displaying a log window comprising information related to the user's actions within the simulation.

18. The method of claim 17, further comprising:
displaying to the user a visual indication in the log window related to the user's performance with respect to the plurality of assessment-monitored events.

19. The method of claim 12, further comprising:
transferring the automated assessment output file to a second simulation system.

20. A computer program product, comprising a non-transitory computer-readable medium having executable computer program code, the computer program product comprising:
a simulation engine module operable to receive input from a user console and to generate a simulation environment;
a user interface module operable to generate a user interface comprising the simulation environment;
an automated assessment module operable to identify a plurality of assessment-monitored events and to generate an evidence-based assessment associated with the plurality of assessment-monitored events based on one or more evaluated criteria; and
a simulation data file module operable to generate an automated assessment output file containing the evidence-based assessment.
